(19) United States
(12) Patent Application Publication
(10) Pub. No.: US 2015/0196018 A1
(43) Pub. Date: Jul. 16, 2015

(54) ICE FISHING EQUIPMENT ORGANIZER

(71) Applicants: Ross D. Werner, Randolph, WI (US); Dylan Werner, Randolph, WI (US)

(72) Inventors: Ross D. Werner, Randolph, WI (US); Dylan Werner, Randolph, WI (US)

(21) Appl. No.: 14/597,780

(22) Filed: Jan. 15, 2015

Related U.S. Application Data
(60) Provisional application No. 61/928,064, filed on Jan. 16, 2014.
(60) Provisional application No. 61/943,914, filed on Feb. 24, 2014.

(51) Int. Cl. A01K 97/01; A01K 97/06

(52) U.S. Cl. CPC A01K 97/01; A01K 97/06

(57) ABSTRACT

An ice fishing equipment organizer is disclosed. The grid is insertable into a multi-gallon container having an interior cavity. The grid has a plurality of dividing walls which extend between a central axis outward to a wall of the container and extend substantially a full depth of the container. The dividing walls form the grid which divides the interior of the container into a plurality of cavities, and wherein the plurality of dividing walls completely isolate and separate more than one piece of equipment in the plurality of cavities.

### CROSS-REFERENCE TO RELATED APPLICATIONS

This application claims the benefit of and priority to U.S. Provisional Patent Application Ser. No. 61/928,064 entitled “ICE FISHING EQUIPMENT ORGANIZER” which was filed Jan. 16, 2014, and U.S. Provisional Patent Application Ser. No. 61/943,914 entitled “ICE FISHING EQUIPMENT ORGANIZER” which was filed Feb. 24, 2014, the entire contents of each of which are hereby incorporated by reference herein in their entirety.

### FIELD

The present inventions relate to the field of ice fishing. The present inventions more specifically relate to the field of organizers for ice fishing equipment.

### BACKGROUND

As is known, ice fishing requires multiple pieces of equipment which must be gathered and carried to the fishing site, as well as stored when not in use. Many ice fishermen currently collect and compile equipment in a container, such as a multi-gallon bucket. For example, a large number of ice fisherman use empty five (5) gallon buckets or six (6) gallon buckets, which buckets are commonly available from hardware stores, fishing equipment stores, and the like, to carry tip ups. Unfortunately, simply placing the equipment into the bucket results in tangled equipment, which is a particular problem when considering that the user must, often times, remove his or her gloves in cold weather to untangle the equipment. Moreover, this can result in tangled or broken equipment.

Currently, there are products commercially available to organize tip ups and jig poles for ice fishing. However, most of these products are fairly expensive, and some require time to assemble after they are purchased. Therefore, a need exists for an ice fishing equipment organizer which is effective, inexpensive, and easy to assemble.

### SUMMARY

Accordingly, an ice fishing equipment organizer is provided. An ice fishing tip up organizer and/or jig pole organizer is provided that fits inside a multi-gallon container.

More specifically, an ice fishing equipment organizer is disclosed. The organizer includes a grid insertable into a multi-gallon container having an interior cavity. The grid has a plurality of dividing walls which extend between a central position or axis outward to a wall of the container and extend substantially a full length or depth of the container. The dividing walls form the grid which divides the interior of the container into a plurality of cavities, and wherein the plurality of dividing walls completely isolate and separate more than one piece of equipment in the plurality of cavities.

An ice fishing equipment organizer is also disclosed including a grid insertable into a multi-gallon container having an interior cavity, wherein the grid has a plurality of dividing walls formed together into a one-piece arrangement and extending substantially a full length or depth of the container. The grid further extends between a central position or axis outward to a wall of the container such that the plurality of dividing walls extend radially from an approximately central axis of the container. The dividing walls form the grid which divides the interior of the container into a plurality of cavities. The organizer also includes a bottom wall coupled to the grid and having a shape substantially corresponding to an interior bottom surface of the container. The grid fits snug inside the container and the plurality of dividing walls completely isolate and separate more than one piece of equipment in the plurality of cavities.

Advantageously, the ice fishing equipment organizer fits inside any standard five (5) gallon or six (6) gallon bucket as well as a multi-gallon fabric bag-type system, and is a one-piece design that slides inside the multi-gallon container without any assembly required or minimal assembly after it is purchased. The organizer prevents tip ups, jig poles, and other equipment placed therein from getting tangled with each other inside the container. The one-piece design includes dividing walls that completely isolate tip ups and other equipment from each other. This keeps tip ups (equipment) from tangling and hooking each other while they are in the container. In this regard, the organizer provides a quick and convenient method for storing and transporting tip ups, jig poles, and other ice fishing equipment without risk of tangling or damage.

These and other features and advantages of devices, systems, and methods according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 is a top plan view illustrating one or more examples of an ice fishing equipment organizer positioned within a container, and further showing example ice fishing equipment separated from the organizer, and a cover removed from the organizer.

FIG. 2 is a top perspective view illustrating one or more examples of the ice fishing equipment organizer shown in FIG. 1, with the ice fishing equipment placed within the organizer inside the container.

FIG. 3 illustrates a top plan view of one or more examples of an ice fishing equipment organizer to be placed within a container as shown in FIG. 1.

FIG. 4 illustrates a side elevation view of one or more examples of an ice fishing equipment organizer of FIG. 3, taken from line 4-4 of FIG. 3.

FIG. 5 illustrates a top plan view of one or more alternative examples of embodiments of an ice fishing equipment organizer to be placed within a container.

FIG. 6 is a perspective view of one or more alternative examples of embodiments of an ice fishing equipment organizer to be placed within a container.

FIG. 7 is a perspective view of a divider segment for the ice fishing equipment organizer shown in FIG. 6.

FIG. 8 is a top plan view of the ice fishing equipment organizer of FIG. 6, taken from line 8-8 of FIG. 6.

FIG. 9 is a cut-away side perspective view of a mating divider segments for the ice fishing equipment organizer shown in FIG. 6.

FIG. 10 is a side elevation view of the ice fishing equipment organizer of FIG. 6, taken from line 10-10 of FIG. 8.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, an ice fishing equipment organizer according to one or more examples of embodiments is illustrated and described. The ice fishing equipment organizer may be used for any suitable fishing equipment, including, but not limited to tip ups, jig poles, and other equipment and tackle.

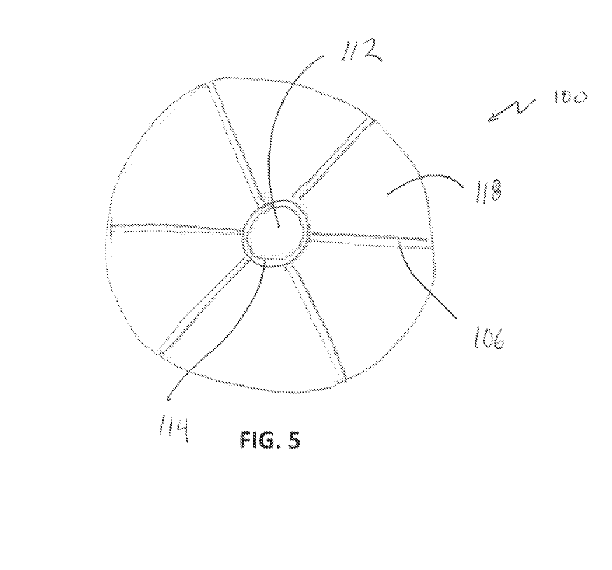

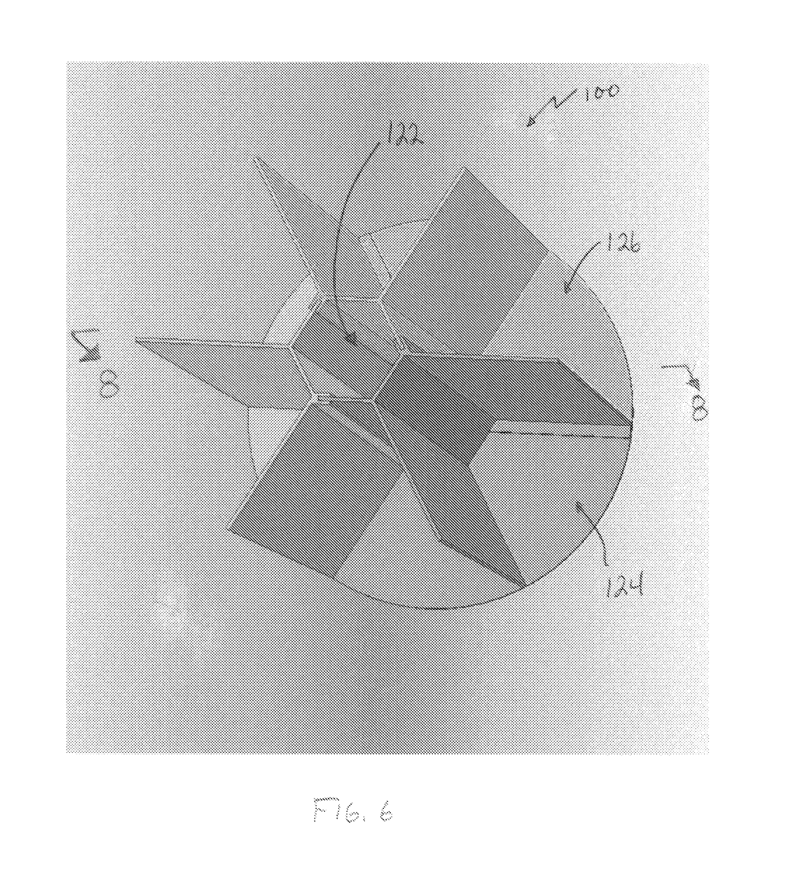

The ice fishing equipment organizer or “organizer” comprises a grid insert or divider 100 for a multi-gallon container 102. In one or more examples of embodiments, the container is a standard five (5) gallon or six (6) gallon bucket. In one or more alternative examples of embodiments, the container is a fabric bag or the like, such as for instance, a fabricated canvas bag. The grid 100 is insertable into the interior cavity 104 of the container 102. The organizer or grid 100 has a plurality of dividing walls 106 which extend between a central position or central axis 108 of the container 102 outward to a wall 110 of the container. In one or more alternative examples of embodiments, an example of which is shown in FIG. 5, a cavity 112 is positioned or formed by a wall 114 or walls centrally located within the divider 100 and one or more dividing walls 106 are positioned radially around the central cavity 112 to extend from the wall(s) 114 forming the central cavity 112 to the container wall. The dividing walls 106 further extend the full length or depth or substantially the full length or depth of the container 102. In one or more examples of embodiments, one or more dividing walls 106 are provided which divide the interior of the container 102 into more than one cavity, for example, two or more cavities 116. In the Figures, a plurality of cavities 116, namely six (6), extending the length or depth, or substantially the length or depth of the container 102 are shown. However, one of skill in the art would understand that any number of cavities, and dividing walls used to form said cavities may be acceptable for the purposes provided. In the illustrated embodiments shown in the Figures, a plurality of dividing walls 106 extend radially from an approximately central point or central axis 108, or in the alternative from a central cavity 112 to the container wall, although variations thereon may also be acceptable. As a result of the foregoing arrangement, the plurality of dividing walls 106 completely isolate and separate more than one piece of equipment in the plurality of cavities 116 within the container 102.

In one or more examples of embodiments, the dividing walls 106 of the organizer or grid or divider are formed together into a one-piece arrangement. In other words, a single divider 100 having multiple walls formed according to a suitable cavity arrangement is provided. While the term “one-piece” is referenced herein, the one-piece divider 100 may be integrally formed as a single unit or alternatively may be a multi-piece unit which is formed and joined together. For example, a multi-part divider 100 may be formed by multiple separate dividing walls 106 which fit together to form the grid 100. In one example, the multiple separate dividing walls 106 may have mating slots. The dividing walls 106 may be rigidly held in place, but in one or more examples may have a degree of flexibility.

The divider 100 further includes, in one or more examples of embodiments, a bottom wall 118 or surface. The bottom wall 118 or surface may be a flat surface having a dimension or shape corresponding to the container's interior bottom surface or wall, or substantially corresponding to the container's interior bottom surface or wall. The dividing walls 106 may be connected to the bottom wall 118 or surface.

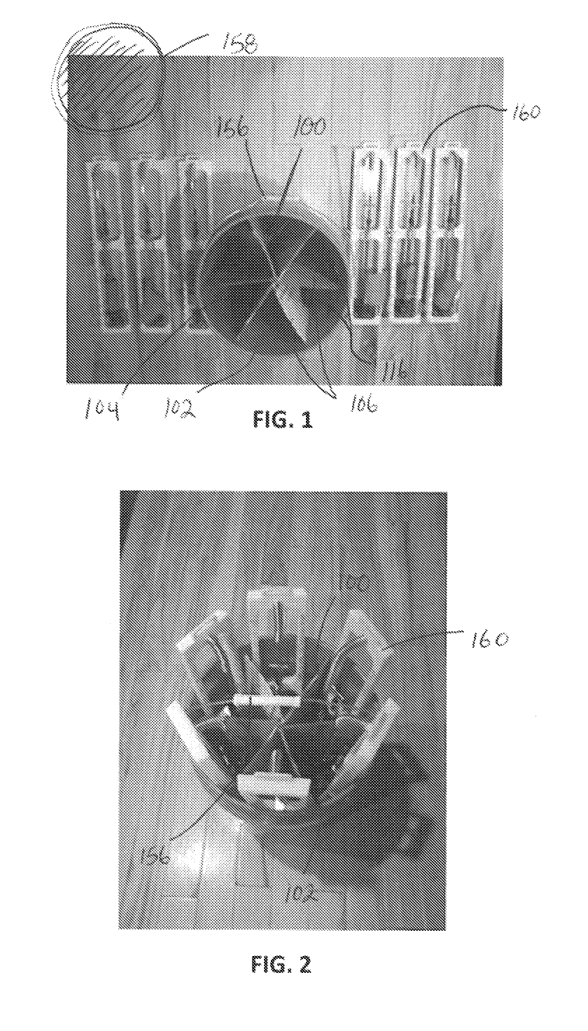

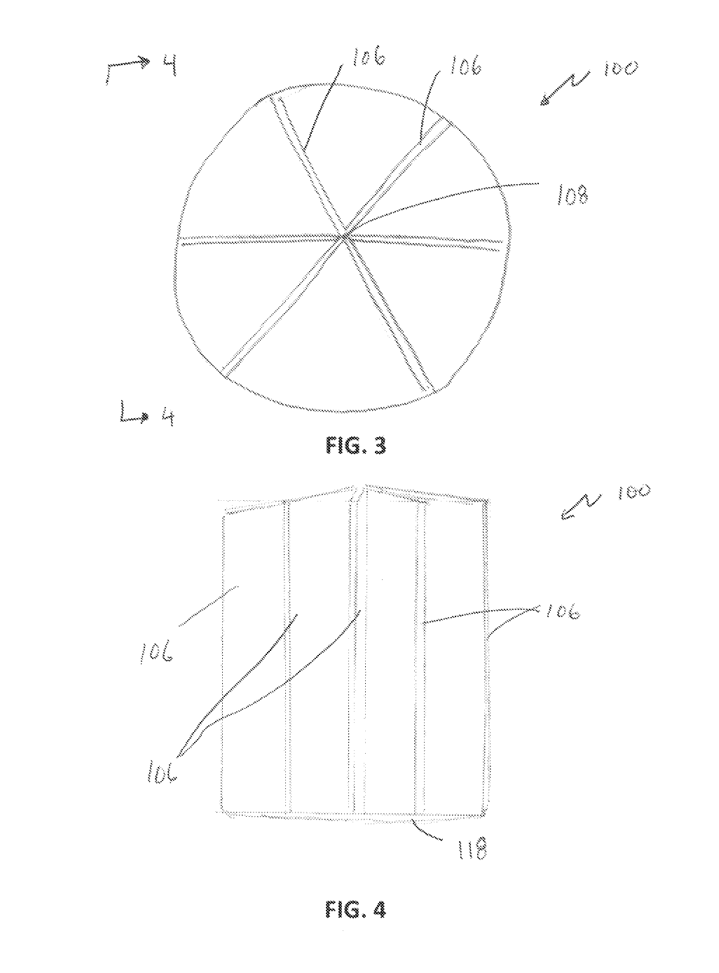

In FIGS. 1-4, the divider 100 is formed of a plurality of dividing walls 106 radiating from a central axis 108, and provided such that the wall extends from the central axis 108 to a wall 110 of the container 102. The bottom wall 118 may be attached to the bottom edge 120 of the plurality of dividing walls 106.

In one or more alternative examples of embodiments, such as shown in FIG. 5, the divider 100 is formed of a plurality of dividing walls 106 radiating from a central cylindrical receptacle or cavity 112 formed by a cylindrical dividing wall or inner cavity wall 114 and provided such that they extend from the cylindrical dividing wall to a wall 110 of the container 102. The bottom wall 118 may be attached to the bottom edge 120 of the plurality of dividing walls 106.

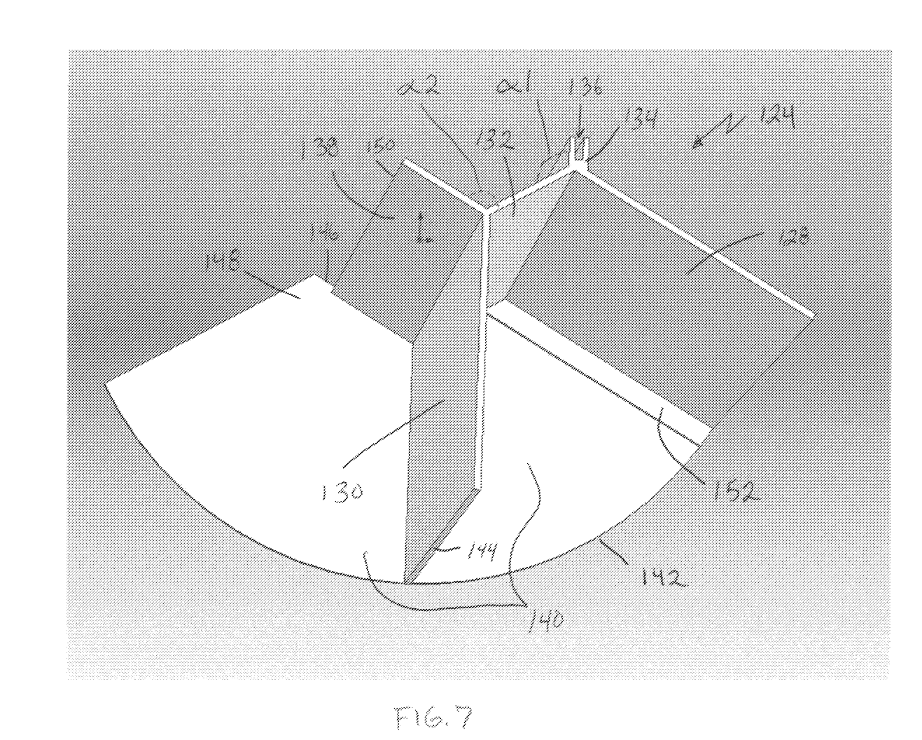

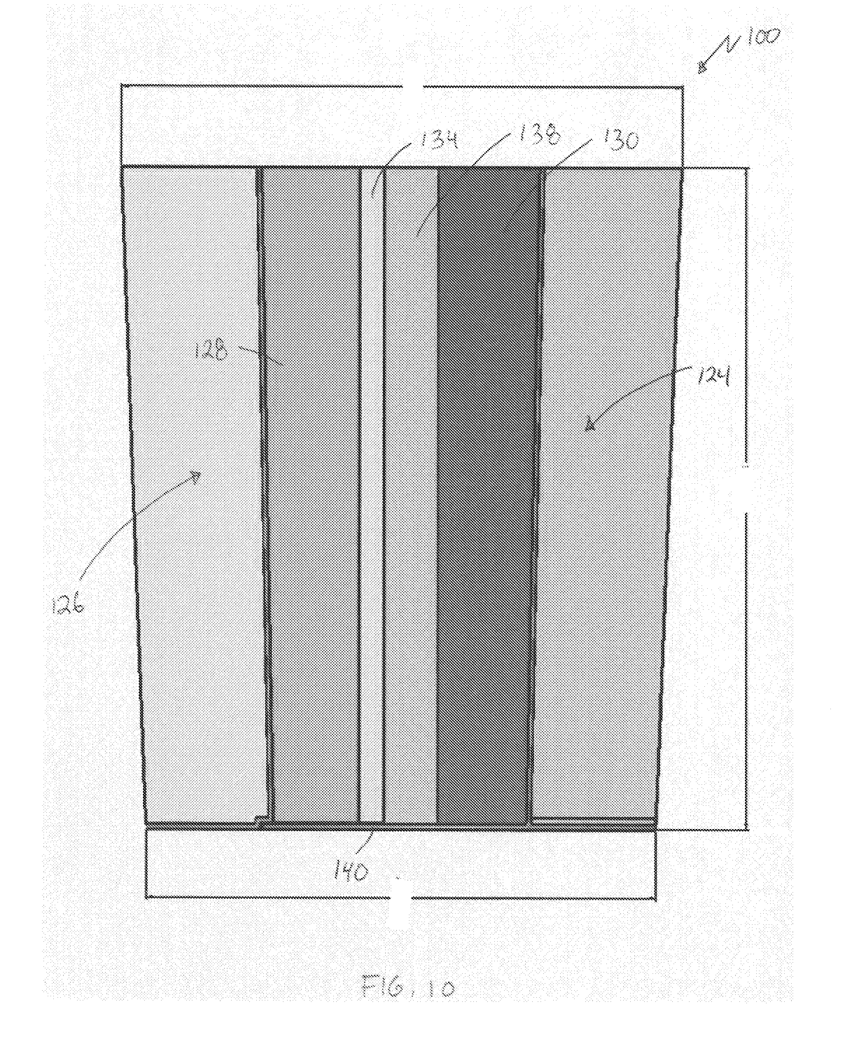

In one or more further alternative examples of embodiments, such as shown in FIGS. 6-11, the divider 100 is formed of a plurality of dividing walls 106 radiating from a central polygonal cavity 122, or cavity wall. The bottom wall 118 is likewise attached to the bottom edge 120 of the plurality of dividing walls.

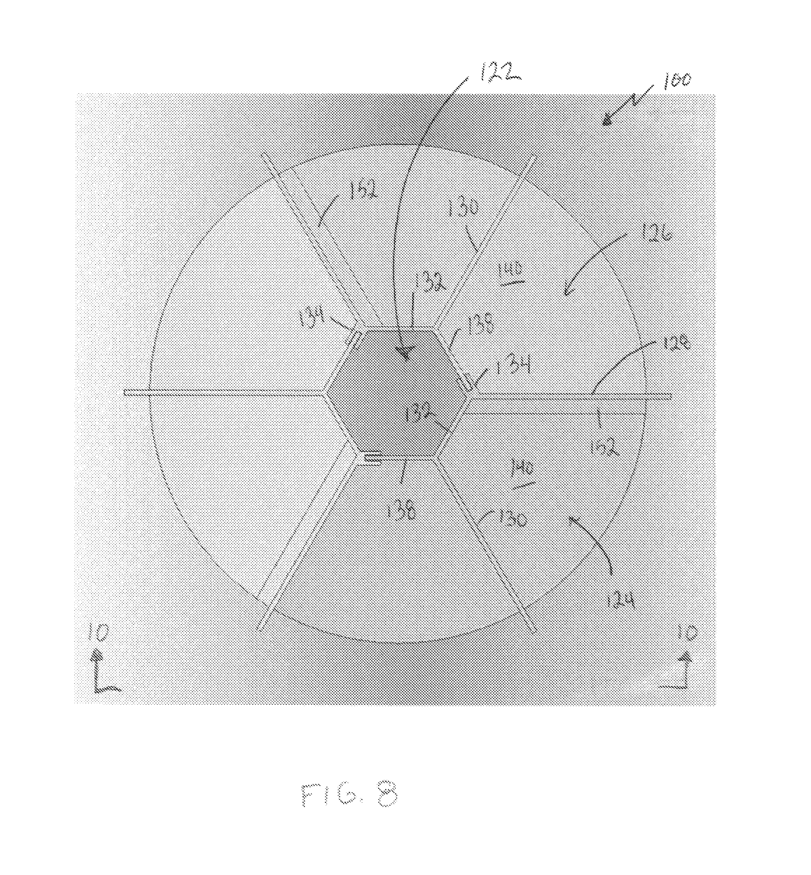

In the embodiment of FIGS. 6-11, a divider assembly is provided which is formed by a plurality of divider segments, e.g., 124, 126, which mate together to form the divider or grid 100. Referring to FIG. 7, each divider segment 124 (or 126) is formed of a first dividing wall 128 and a second dividing wall 130 joined by a first inner cavity wall 132. At the intersection of the first inner cavity wall 132 and the first dividing wall 128 is a receptor 134 extending away from the first inner cavity wall 132 and first dividing wall 128. The receptor 134 extends at an obtuse angle (α1) from the first inner cavity wall 132 is formed by a vertical slot 136 extending the length or height of the first dividing wall 128 and first inner cavity wall 132. A second inner cavity wall 138 extends from the intersection of the second dividing wall 130 and the first inner cavity wall 132. The second inner cavity wall 138 extends at an obtuse angle (α2) from the first inner cavity wall 132 and may extend at an angle which mirrors the angle of the receptor 134. The dividing walls and inner cavity walls each extend perpendicular to a bottom wall segment 140. The bottom wall segment 140 is joined to the bottom edge 120 of the dividing walls and inner cavity walls. The bottom wall segment 140 has an outer radial edge 142 which is co-terminus with the outer edge 144 of the first and second dividing walls 128, 130, and has an inner edge 146 which is aligned with or substantially aligned with the inner cavity walls 132, 138. The bottom wall segment 140 has an extended bottom wall section 148 which extends beyond an outer edge 150 of the second inner cavity wall 138. The bottom wall segment 140 also has a raised recessed section 152 adjacent the first dividing wall 128 which raised recessed section 152 has a depth which is sized to receive an extended bottom wall section 148.

As can be seen by reference to FIGS. 6 and 8-10, the plurality of divider segments 124, 126 mate together by engagement of the receptor 134 slot 136 on a first divider segment 124 with a second inner cavity wall 138 on an adjacent second divider segment 126, along with the engagement of the extended bottom wall section 148 of the adjacent second divider segment 126 with the raised recessed section 152 of the first divider segment 124. Additional divider segment(s) are joined in a like manner to form the divider or grid 100 shown in FIG. 6.

In one or more specific examples of embodiments, the divider or grid 100 shown in FIGS. 6-10 may have an inner cavity 152 with an opening ranging from approximately 1.25 to 2.50 inches, and more preferably is approximately 2.50 inches. The divider segment 124 may have first and second dividing walls 128, 130 which join to the first inner cavity wall 132 and are spaced approximately 1.50 to 1.60 inches apart and more preferably may be approximately 1.55 inches apart. The bottom wall segment 140 outer radial edge 142 may extend from 3.6 inches to 3.7 inches from the first inner cavity wall 132 and is preferably approximately 3.67 inches. The outer edge 144 of the first and second dividing walls 128, 130 which are in contact with the bottom wall segment 140 are spaced approximately 4.9 to 5.0 inches apart, and more preferably are spaced approximately 4.99 inches apart. The length or height or depth of each divider or grid 100 may be approximately 13.0 inches.

As indicated, the one-piece organizer design fits snug inside a container 102. The one-piece organizer may serve as an internal skeleton for the container, such as when used in a fabric bag system. It is also contemplated that the one-piece organizer may be contained within a container and such combination may be further contained within a fabric bag system. It is contemplated that the container 102 may be of any suitable size for the intended purposes. The container 102 has an interior cavity 104 or recess which receives the organizer. The container 102 may also include a handle 156 (FIG. 1) for transport. Optionally, a cover 158 (FIG. 1) may be provided for the bucket 102 in one or more embodiments. The container 102 may be any commercially available device, although it is contemplated that the container 102 may be specially made for the purposes described. In alternative examples of embodiments, such as in the case of a fabric bag system, the cover may be formed by a zipper or toggled closure on the top of the bag.

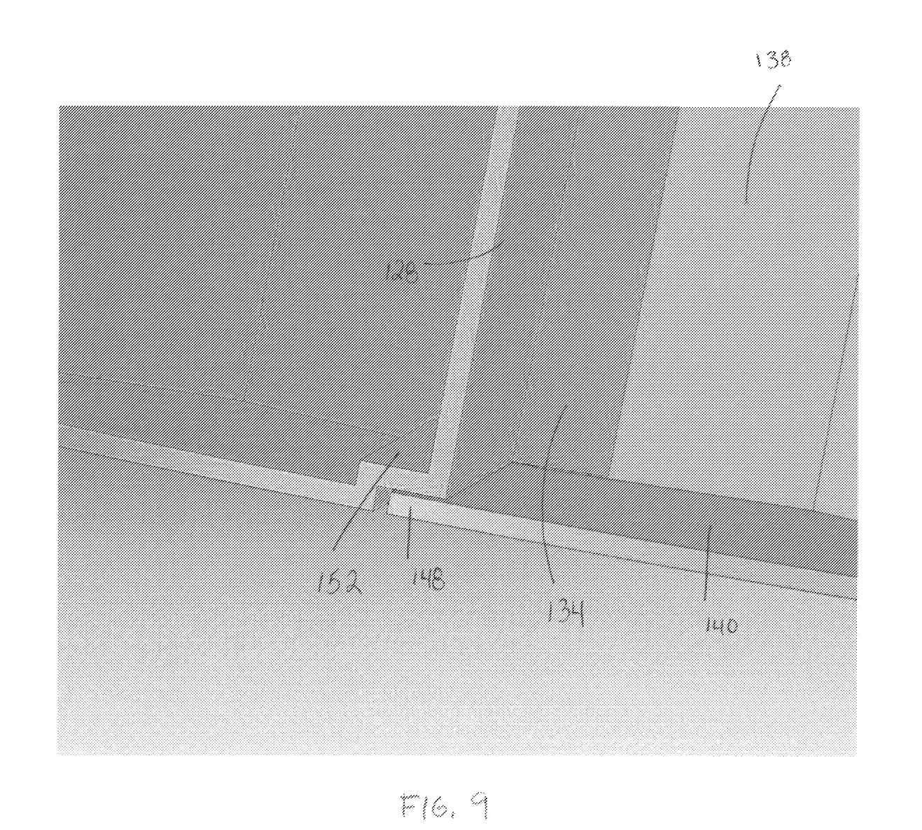

In one or more examples of embodiments, such as that shown in FIGS. 8 & 10, the dividing wall may be wider on the upper edge than on the bottom edge such that the outer circumference or footprint of the divider or grid 100 is greater at the top than the bottom. In this regard, the divider 100 may be formed so as to align with a varying or increasing diameter container 102. The divider 100 in one or more specific examples of embodiments has a base diameter of approximately 10.0 inches to 10.1 inches, and more preferably approximately 10.06 inches and an upper diameter of approximately 11.0 inches to 11.1 inches, and more preferably approximately 11.09 inches.

In one or more examples of embodiments, the one-piece organizer or divider 100 is formed by injection molding, and is formed of a single material, such as plastic. However, alternative rigid or semi-rigid, or reinforced materials suitable for the intended purposes may also be acceptable. Likewise, alternative methods of producing the organizer, such as, but not limited to, by 3-D printing may also be acceptable. Preferably, the organizer is formed having dividing walls 106 molded and shaped to completely isolate and separate from each other within the container 102 or cavity more than one piece of equipment, such as multiple tip ups, placed in the cavities.

The organizer or grid or divider may be formed as one unit or in one operation. In one or more alternative examples of embodiments, the organizer and its plurality of dividing walls 106 may be formed of multiple pieces, or as a multi-part divider 100 (e.g., FIGS. 6-10). In this regard, one or more of the dividing walls 106 or segments may be separately formed and joined together. Likewise, the bottom wall 118 may be separately formed and joined to the dividing walls 106. In this example, one or more of the dividing walls 106 and/or bottom wall 118 may have a mechanism to attach the respective dividing walls together to form the organizer. For example, as described above the dividing walls may be provided with corresponding or mating slots or receptors. In the alternative, a tongue and groove type arrangement may also be used. Likewise, the bottom wall may have various mechanisms for attachment to the dividing walls 106, such as for example, a snap-fit type connecting element or may be molded or adhered thereto. While specific examples are described, one of skill in the art would understand that any now known or future developed means to combine the multiple dividing walls 106 and bottom wall may be acceptable for the purposes provided.

In the above-described example in which a plurality of dividing walls 106 is formed, the dividing walls 106 and base may be formed of similar materials, such as plastic, and formed by similar means, such as a mold. The dividing walls 106 and bottom wall may then be engaged using the appropriate means for joining the dividing walls 106 and bottom wall, examples of which are described above. The plurality of dividing walls 106 and/or bottom wall may be further secured together by adhesive, or for example, by the application of heat or other means to melt and blend the components together. The organizer or grid 100 may be created according to the foregoing means separately from the container 102 and inserted into the container, or assembled within the container.

One or more examples of use of the invention will now be described. A multi-gallon container 102 as described herein may be obtained. An ice fishing equipment organizer 100 having the desired cavity arrangement is also acquired. The organizer 100 is sized to fit snugly within the container 102. Accordingly, the organizer 100 is inserted into the container 102, and preferably fully inserted. The organizer 100 may be inserted such that the bottom wall 118 is placed in contact with the bottom of the container 102 and more specifically the container's interior bottom surface or wall, and may be flush therewith. Ice fishing equipment 160 is then placed in the respective cavities 116 formed by the organizer 100 received within the container 102. For example, individual tip ups may be placed inside individual chambers or cavities to keep them isolated, protected and tangle free.

Advantageously, the ice fishing equipment organizer fits inside any standard five (5) gallon bucket or six (6) gallon bucket as well as inside a multi-gallon fabric bag system, and is a one-piece design that slides inside the container 102 without any assembly required after it is purchased. Importantly, the dividing walls which extend the full length or depth, or substantially the full length or depth, of the container prevent ice fishing equipment, such as tip ups, jig poles, and other equipment, therein from getting tangled with each other inside the container. The one-piece design includes dividing walls that completely isolate tip ups and other equipment from each other within the container. This keeps tip ups (equipment) from tangling and hooking each other while they are in the container. In this regard, the organizer provides a quick and convenient method for storing and transporting tip ups, jig poles, and other ice fishing equipment without risk of tangling or damage.

In addition to the advantages already set forth above, the ice fishing equipment organizer is low cost due to the use of a one-piece plastic design, and therefore affordable. Furthermore, each tip up or other piece of equipment is isolated from each other, so even if a hook is hanging loose inside, it cannot come in contact with other tip ups (equipment) in the container. The ice fishing equipment organizer is also easy to use as no assembly is required by the end user. The end user must simply slide the organizer it into a container and it is ready to go. In fact, the organizer provides various further advantages to the end user in that it fits within empty multi-gallon containers used by, and often already owned by, many ice fishermen. As a result, the ice fisherman does not need to purchase any additional containers for storage of equipment.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. An ice fishing equipment organizer comprising:
a grid insertable into a multi-gallon container having an interior cavity, wherein the grid has a plurality of dividing walls which extend between a central axis outward to a wall of the container and extend substantially a full depth of the container, the dividing walls form the grid which divides the interior of the container into a plurality of cavities, wherein the plurality of dividing walls completely isolate and separate more than one piece of equipment in the plurality of cavities.

2. The ice fishing equipment organizer of claim 1, further comprising a cavity positioned centrally within the grid formed by a cavity wall, wherein one or more dividing walls are positioned radially around the central cavity and extend from the cavity wall.

3. The ice fishing equipment organizer of claim 1, wherein the container is a five gallon bucket or six gallon bucket.

4. The ice fishing equipment organizer of claim 1, wherein the plurality of cavities is six cavities.

5. The ice fishing equipment organizer of claim 1, wherein the plurality of dividing walls extend radially from an approximately central axis.

6. The ice fishing equipment organizer of claim 1, further comprising a bottom wall coupled to the grid and having a shape substantially corresponding to an interior bottom surface of the container.

7. The ice fishing equipment organizer of claim 6, wherein the plurality of dividing walls are connected to the bottom wall.

8. The ice fishing equipment organizer of claim 7, wherein the bottom wall has a snap-fit connecting element which connects to a corresponding element on one or more dividing walls from the plurality of dividing walls.

9. The ice fishing equipment organizer of claim 1, wherein the grid fits snug inside the interior cavity of the container.

10. The ice fishing equipment organizer of claim 1, wherein the container includes a handle.

11. The ice fishing equipment organizer of claim 1, wherein the container includes a cover.

12. The ice fishing equipment organizer of claim 1, wherein the grid having the plurality of dividing walls is formed together in a one-piece arrangement.

13. The ice fishing equipment organizer of claim 1, wherein the grid is an injection molded single piece.

14. The ice fishing equipment organizer of claim 1, wherein the grid is a multi-part divider formed by multiple separate dividing walls which fit together to form the grid.

15. The ice fishing equipment organizer of claim 14, wherein the multiple separate dividing walls have mating slots.

16. An ice fishing equipment organizer comprising:
a grid insertable into a multi-gallon container having an interior cavity, wherein the grid has a plurality of dividing walls formed together into a one-piece arrangement and extending substantially a full depth of the container, and further extending between a central axis outward to a wall of the container such that the plurality of dividing walls extend radially from an approximately central axis of the container, the dividing walls form the grid which divides the interior of the container into a plurality of cavities;
further comprising a bottom wall coupled to the grid and having a shape substantially corresponding to an interior bottom surface of the container;
wherein the grid fits snug inside the container; and
wherein the plurality of dividing walls completely isolate and separate more than one piece of equipment in the plurality of cavities.

17. The ice fishing equipment organizer of claim 16, further comprising a cavity positioned centrally within the grid formed by a cavity wall, wherein one or more dividing walls are positioned radially around the central cavity and extend from the cavity wall.

18. The ice fishing equipment organizer of claim 16, wherein the container is a five gallon bucket or six gallon bucket.

19. The ice fishing equipment organizer of claim 16, wherein the grid is an injection molded single piece.

20. The ice fishing equipment organizer of claim 16, wherein the grid is a multi-part divider formed by multiple separate dividing walls which fit together to form the grid.
